(19) United States
(12) Patent Application Publication
(10) Pub. No.: US 2025/0021579 A1
(43) Pub. Date: Jan. 16, 2025

(54) IMPLEMENTING DATA MODIFICATIONS ACROSS DISTRIBUTED SYSTEMS

(71) Applicant: International Business Machines Corporation, Armonk, NY (US)

(72) Inventors: Harish Sharma, Pune (IN); Biswajit Roy, Bengaluru (IN); Rupam Bhattacharjee, Karimganj (IN); Ganesh Govindrao Chaudhari, Pune (IN)

(21) Appl. No.: 18/222,291

(22) Filed: Jul. 14, 2023

(51) Int. Cl. G06F 16/27

(52) U.S. Cl. CPC G06F 16/275

(57) ABSTRACT

A computer-implemented method, according to one embodiment, includes: receiving multiple data blocks from a central data storage location, and modifying data in one or more of the received data blocks. Modifying data in one or more of the data blocks further includes creating copies of the one or more data blocks and the data included therein, and modifying the data in the copies of the one or more data blocks. A copy of the modified data blocks are sent to the central data storage location. Moreover, the modified data blocks are used to replace corresponding ones of the data blocks received from the central data storage location in response to receiving an indication that the modified data blocks have been implemented at the central data storage location.

### BACKGROUND

The present invention relates to distributed storage systems, and more specifically, this invention relates to processing data at remote locations and maintaining an updated copy at a central data storage location.

As computing power continues to advance and the use of IoT devices becomes more prevalent, the amount of data produced continues to increase. For instance, the rise of smart enterprise endpoints has led to large amounts of data being generated at remote locations. Data production will only further increase with the growth of 5G networks and an increased number of connected mobile devices.

This issue has also become more prevalent as the complexity of machine learning models increases. Increasingly complex machine learning models translate to more intense workloads and increased strain associated with applying the models to received data. The operation of conventional implementations has thereby been negatively impacted.

While cloud computing has been implemented in conventional systems in an effort to improve the ability to process this increasing amount of data, the unprecedented scale and complexity at which data is being created has outpaced network and infrastructure capabilities. Sending all device-generated data to a centralized data center or to a cloud location has resulted in bandwidth and latency issues in conventional systems.

### SUMMARY

A computer-implemented method, according to one embodiment, includes: receiving multiple data blocks from a central data storage location, and modifying data in one or more of the received data blocks. Modifying data in one or more of the data blocks further includes creating copies of the one or more data blocks and the data included therein, and modifying the data in the copies of the one or more data blocks. A copy of the modified data blocks are sent to the central data storage location. Moreover, the modified data blocks are used to replace corresponding ones of the data blocks received from the central data storage location in response to receiving an indication that the modified data blocks have been implemented at the central data storage location.

A computer program product, according to another embodiment, includes a computer readable storage medium having program instructions embodied therewith. The program instructions are readable by a processor, executable by the processor, or readable and executable by the processor, to cause the processor to perform the foregoing method.

A system, according to yet another embodiment, includes: a processor, and logic that is integrated with the processor, executable by the processor, or integrated with and executable by the processor. Moreover, the logic is configured to perform the foregoing method.

Other aspects and embodiments of the present invention will become apparent from the following detailed description, which, when taken in conjunction with the drawings. illustrate by way of example the principles of the invention.

### BRIEF DESCRIPTION OF THE DRAWINGS

FIG. 1 is a diagram of a computing environment, in accordance with one embodiment.

FIG. 2 is a diagram of a tiered data storage system, in accordance with one embodiment.

FIG. 3 is a diagram of a distributed data storage and processing system, in accordance with one embodiment.

FIG. 4 is a flowchart of a method, in accordance with one embodiment.

FIG. 5A is a flowchart of sub-operations for performing a new data write operation, in accordance with one embodiment.

FIG. 5B is a partial representational view of a cache, in accordance with one embodiment.

FIG. 6A is a flowchart of sub-operations for performing a data deletion operation, in accordance with one embodiment.

FIG. 6B is a partial representational view of a cache, in accordance with one embodiment.

### DETAILED DESCRIPTION

The following description is made for the purpose of illustrating the general principles of the present invention and is not meant to limit the inventive concepts claimed herein. Further, particular features described herein can be used in combination with other described features in each of the various possible combinations and permutations.

Unless otherwise specifically defined herein, all terms are to be given their broadest possible interpretation including meanings implied from the specification as well as meanings understood by those skilled in the art and/or as defined in dictionaries, treatises, etc.

It must also be noted that, as used in the specification and the appended claims, the singular forms “a,” “an” and “the” include plural referents unless otherwise specified. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The following description discloses several preferred embodiments of systems, methods and computer program products for processing data at remote locations and maintaining an updated copy at a central data storage location. Implementations herein are able to improve performance in a number of ways by returning data blocks having modified data to a central data storage location. For example, less compute throughput is consumed at the central data storage location because only data that has been updated (changed) is rewritten, while avoiding data that has not been updated. Additionally, less data is sent between a user location and a central data storage location as a result, thereby reducing network traffic, e.g., as will be described in further detail below.

In one general embodiment, a computer-implemented method includes: receiving multiple data blocks from a central data storage location, and modifying data in one or more of the received data blocks. Modifying data in one or more of the data blocks further includes creating copies of the one or more data blocks and the data included therein, and modifying the data in the copies of the one or more data blocks. A copy of the modified data blocks are sent to the central data storage location. Moreover, the modified data blocks are used to replace corresponding ones of the data blocks received from the central data storage location in response to receiving an indication that the modified data blocks have been implemented at the central data storage location.

In another general embodiment, a computer program product includes a computer readable storage medium having program instructions embodied therewith. The program instructions are readable by a processor, executable by the processor, or readable and executable by the processor, to cause the processor to: perform the foregoing method.

In another general embodiment, a system includes: a processor, and logic that is integrated with the processor, executable by the processor, or integrated with and executable by the processor. Moreover, the logic is configured to: perform the foregoing method.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as improved data storage code at block 150 for processing data at remote locations and maintaining an updated copy at a central data storage location. In addition to block 150, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 150, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

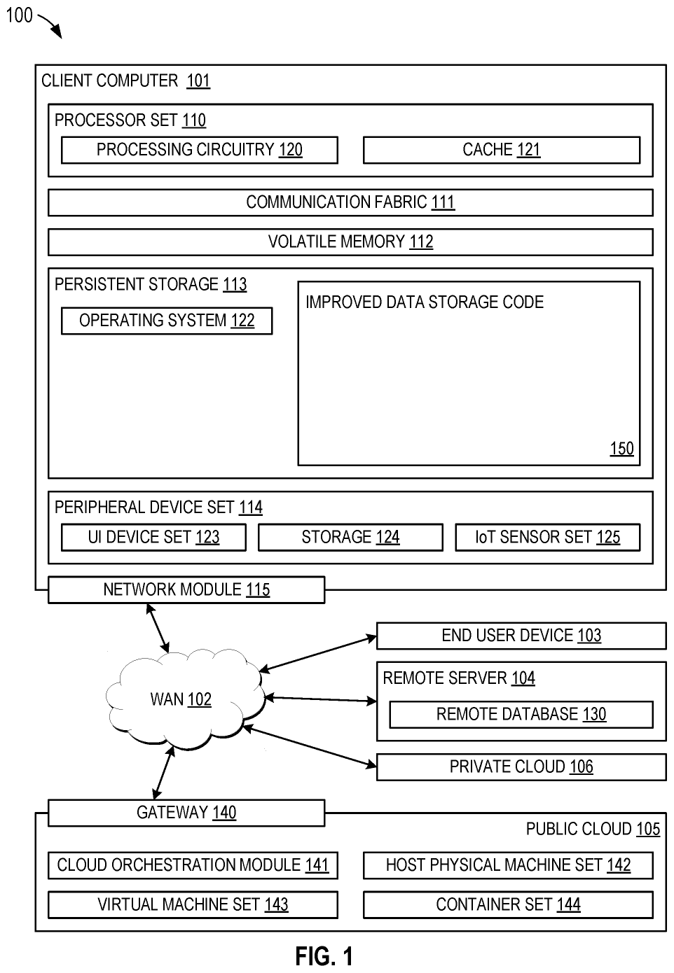

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 150 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 150 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

In some respects, a system according to various embodiments may include a processor and logic integrated with and/or executable by the processor, the logic being configured to perform one or more of the process steps recited herein. The processor may be of any configuration as described herein, such as a discrete processor or a processing circuit that includes many components such as processing hardware, memory, I/O interfaces, etc. By integrated with, what is meant is that the processor has logic embedded therewith as hardware logic, such as an application specific integrated circuit (ASIC), a FPGA, etc. By executable by the processor, what is meant is that the logic is hardware logic; software logic such as firmware, part of an operating system, part of an application program; etc., or some combination of hardware and software logic that is accessible by the processor and configured to cause the processor to perform some functionality upon execution by the processor. Software logic may be stored on local and/or remote memory of any memory type, as known in the art. Any processor known in the art may be used, such as a software processor module and/or a hardware processor such as an ASIC, a FPGA, a central processing unit (CPU), an integrated circuit (IC), a graphics processing unit (GPU), etc.

Of course, this logic may be implemented as a method on any device and/or system or as a computer program product, according to various embodiments.

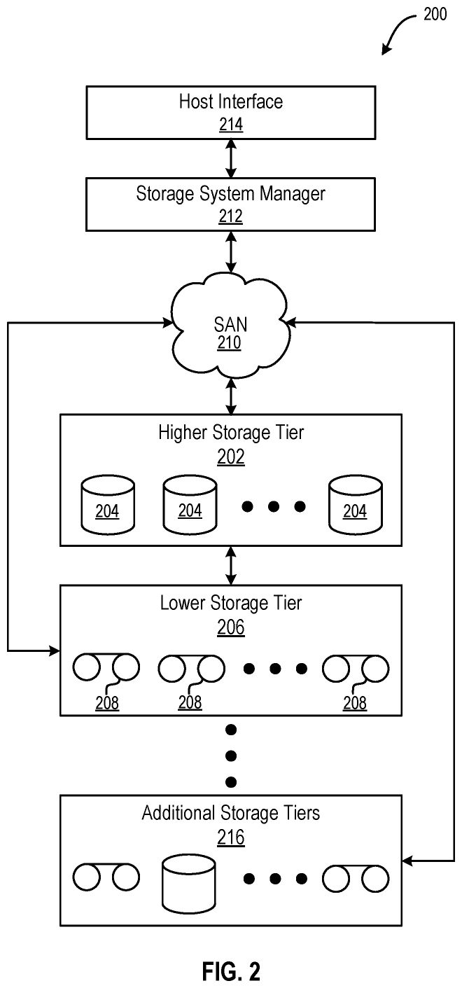

Now referring to FIG. 2, a storage system 200 is shown according to one embodiment. Note that some of the elements shown in FIG. 2 may be implemented as hardware and/or software, according to various embodiments. The storage system 200 may include a storage system manager 212 for communicating with a plurality of media and/or drives on at least one higher storage tier 202 and at least one lower storage tier 206. The higher storage tier(s) 202 preferably may include one or more random access and/or direct access media 204, such as hard disks in hard disk drives (HDDs), nonvolatile memory (NVM), solid state memory in solid state drives (SSDs), flash memory, SSD arrays, flash memory arrays, etc., and/or others noted herein or known in the art. The lower storage tier(s) 206 may preferably include one or more lower performing storage media 208, including sequential access media such as magnetic tape in tape drives and/or optical media, slower accessing HDDs, slower accessing SSDs, etc., and/or others noted herein or known in the art. One or more additional storage tiers 216 may include any combination of storage memory media as desired by a designer of the system 200. Also, any of the higher storage tiers 202 and/or the lower storage tiers 206 may include some combination of storage devices and/or storage media.

The storage system manager 212 may communicate with the drives and/or storage media 204, 208 on the higher storage tier(s) 202 and lower storage tier(s) 206 through a network 210, such as a storage area network (SAN), as shown in FIG. 2, or some other suitable network type. The storage system manager 212 may also communicate with one or more host systems (not shown) through a host interface 214, which may or may not be a part of the storage system manager 212. The storage system manager 212 and/or any other component of the storage system 200 may be implemented in hardware and/or software, and may make use of a processor (not shown) for executing commands of a type known in the art, such as a central processing unit (CPU), a field programmable gate array (FPGA), an application specific integrated circuit (ASIC), etc. Of course, any arrangement of a storage system may be used, as will be apparent to those of skill in the art upon reading the present description.

In more embodiments, the storage system 200 may include any number of data storage tiers, and may include the same or different storage memory media within each storage tier. For example, each data storage tier may include the same type of storage memory media, such as HDDs, SSDs, sequential access media (tape in tape drives, optical disc in optical disc drives, etc.), direct access media (CD-ROM, DVD-ROM, etc.), or any combination of media storage types. In one such configuration, a higher storage tier 202, may include a majority of SSD storage media for storing data in a higher performing storage environment, and remaining storage tiers, including lower storage tier 206 and additional storage tiers 216 may include any combination of SSDs, HDDs, tape drives, etc., for storing data in a lower performing storage environment. In this way, more frequently accessed data, data having a higher priority, data needing to be accessed more quickly, etc., may be stored to the higher storage tier 202, while data not having one of these attributes may be stored to the additional storage tiers 216, including lower storage tier 206. Of course, one of skill in the art, upon reading the present descriptions, may devise many other combinations of storage media types to implement into different storage schemes, according to the embodiments presented herein.

According to some embodiments, the storage system (such as 200) may include logic configured to receive a request to open a data set, logic configured to determine if the requested data set is stored to a lower storage tier 206 of a tiered data storage system 200 in multiple associated portions, logic configured to move each associated portion of the requested data set to a higher storage tier 202 of the tiered data storage system 200, and logic configured to assemble the requested data set on the higher storage tier 202 of the tiered data storage system 200 from the associated portions.

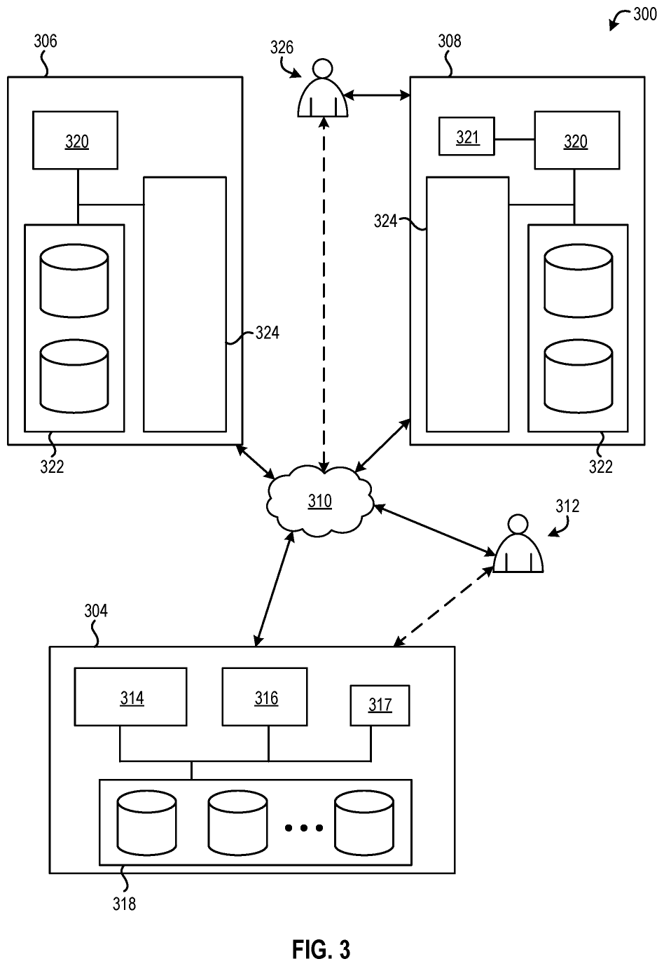

It follows that storage system 200 is able to use different types of memory to implement different levels of performance. For instance, the storage system manager 212 is used to control where data is processed and/or stored in the system 200, where each location is capable of achieving a different outcome. Similarly, FIG. 3 below shows a system 300 having a central data storage location 304 that may implement a tiered data storage architecture, e.g., as seen in FIG. 2.

As noted above, data production has continued to increase as computing power and the use of IoT devices advance. For instance, the rise of smart enterprise endpoints has led to large amounts of data being generated at remote locations. Data production will only further increase with the growth of 5G networks and an increased number of connected mobile devices. This issue has also become more prevalent as the complexity of machine learning models increases. Increasingly complex machine learning models translate to more intense workloads and increased strain associated with applying the models to received data. The operation of conventional implementations has thereby been negatively impacted.

While cloud computing has been implemented in conventional systems in an effort to improve the ability to process this increasing amount of data, the unprecedented scale and complexity at which data is being created has outpaced network and infrastructure capabilities. Sending all device-generated data to a centralized data center or to a cloud location has resulted in bandwidth and latency issues in conventional systems.

For instance, conventional systems have been forced to copy all data (including unmodified data) back to a central location, thereby suffering unnecessary and detrimental impacts on compute and/or network throughput. Moreover, these conventional systems modify data without keeping track of what specific portions of data have been updated. Accordingly, conventional systems have no choice but to copy all data back to a central copy and suffer these performance limitations.

In sharp contrast to these conventional drawbacks, implementations herein are able to improve performance in a number of ways by transferring only the data blocks having modified data to a central data storage location. As a result, less compute throughput is consumed at the central data storage location because only data that has been updated (changed) is rewritten, while avoiding data that has not been updated. Additionally, less data is sent between a user location and a central data storage location as a result, thereby reducing network traffic, e.g., as will be described in further detail below.

Looking now to FIG. 3, a distributed data storage and processing system 300 is shown in accordance with one embodiment. As an option, the present system 300 may be implemented in conjunction with features from any other embodiment listed herein, such as those described with reference to the other FIGS., such as FIGS. 1-2. However, this system 300 and others presented herein may be used in various applications and/or in permutations which may or may not be specifically described in the illustrative embodiments listed herein. Further, the system 300 presented herein may be used in any desired environment. Thus FIG. 3 (and the other FIGS.) may be deemed to include any possible permutation.

As shown, a central data storage location 304 (e.g., central server) is connected to remote user locations 306, 308 over network 310. An administrator 312 of the central data storage location 304 is also shown as being connected to network 310. In some implementations, the administrator 312 may be directly connected to the central data storage location 304 as represented by the dashed arrowed line. It follows that the administrator 312 may be able to control at least a portion of the central data storage location 304, e.g., updating software being run by a central processor 314.

It should also be noted that “connect(ing)” and “communicate” as used herein are intended to refer to any desired type of connection between two points that allows for the exchange of information therebetween. In other words, data, instructions, commands, responses, user inputs, etc. may be sent between any two or more locations (components) that are configured to communicate with each other as a result of being directly and/or indirectly connected to each other, e.g., as would be appreciated by one skilled in the art after reading the present description.

For instance, the network 310 indirectly connects each of the central data storage location 304 and the user locations 306, 308. Depending on the approach, the network 310 may be of any type. For instance, in some approaches the network 310 is a WAN, e.g., such as the Internet. However, an illustrative list of other network types which network 310 may implement includes, but is not limited to, a LAN, a PSTN, a SAN, an internal telephone network, etc. Accordingly, the central data storage location 304 and the user locations 306, 308 are able to communicate with each other regardless of the amount of separation which exists therebetween, e.g., despite being positioned at different geographical locations.

As noted above, the central data storage location 304 includes a central processor 314. In some approaches, the central processor 314 includes a large (e.g., robust) controller that is coupled to a cache 316 and a data storage array 318 having a relatively high storage capacity. The central data storage location 304 is thereby able to process and store a relatively large amount of data, allowing it to be connected to, and communicate with, multiple different remote locations. As noted above, the central data storage location 304 may receive data, commands, etc. from any number of user locations (e.g., remote servers). The components included in the central data storage location 304 thereby preferably have a higher achievable throughput than components included in each of the user locations 306, 308, to accommodate the higher flow of data experienced at the central data storage location 304.

It should be noted that with respect to the present description, “data” may include any desired type of information. For instance, data may include one or more data blocks, each of which includes about the same amount of data. These data blocks may thereby serve as logical partitions between subsets of data, e.g., as would be appreciated by one skilled in the art after reading the present description. In different implementations data can include raw sensor data, metadata, program commands, instructions, etc. It follows that the processor 314 may use the cache 316 and/or storage array 318 to cause one or more data operations to be performed. According to an example, the processor 314 at the central data storage location 304 may cause one or more data write operations to be performed in memory at the storage array 318.

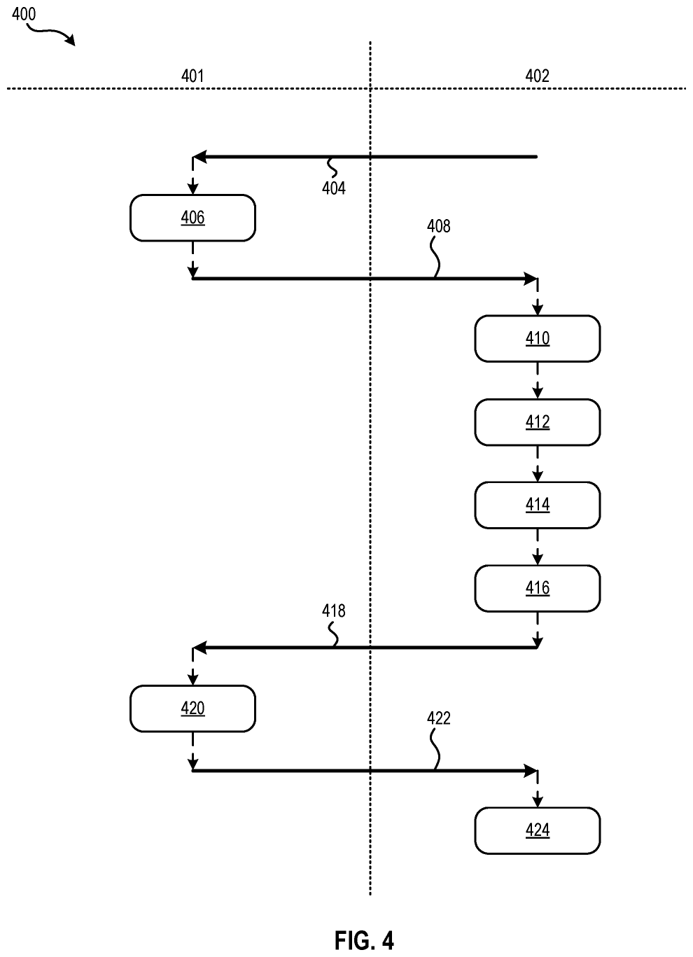

The central data storage location 304 may even include a file processing component 317 that is configured to recognize partial data (e.g., a subset of data blocks) for an existing file. The file processing component 317 may thereby be able to update data using metadata information received along with modified data blocks from the user locations 306, 308. While the file processing component 317 is shown as a standalone component in the present depiction, in other implementations the file processing component may be implemented as a software that runs on the central processor 314. It follows that the file processing component 317 may be used to perform one or more of the operations that are shown as occurring at node 401 included below in method 400 of FIG. 4.

With continued reference to FIG. 3, each of the user locations 306, 308 include a processor 320 coupled to memory 322 as well as cache 324. While the user locations 306, 308 are depicted as including similar components and/or construction, it should be noted that any desired components may be implemented in any desired arrangement. In some instances, each remote user location in a system may be configured differently to provide each location with a different ability.

For example, a file processing component 321 is shown as being located at user location 308. The file processing component 321 is preferably able to perform partial data update operations (e.g., partial file writes), as well as full update operations (e.g., full file writes), e.g., depending on the number of data blocks modified, deleted, added by the user, etc. As noted above, while the file processing component 321 is shown as a standalone component in the present depiction, in other implementations the file processing component may be implemented as software that runs on the processor 320. It follows that the file processing component 321 may be used to perform one or more of the operations that are shown as occurring at node 402 included below in method 400 of FIG. 4. In some approaches, the file processing component 321 may implement a copy on write implementation, e.g., as would be appreciated by one skilled in the art after reading the present description. In another example, which is in no way intended to limit the invention, user location 306 of FIG. 3 may include a cryptographic module (not shown) that allows the user location 306 to produce encrypted data, while user location 308 includes a data compression module (not shown) that allows the user location 308 to produce compressed data.

It follows that the different locations (e.g., servers) in system 300 may have different performance capabilities. As noted above, the central data storage location 304 may have a higher achievable throughput compared to the user locations 306, 308. While this may allow the central data storage location 304 the ability to perform more data operations in a given amount of time than the user locations 306, 308, other factors impact achievable performance. For example, traffic over network 310 may limit the amount of data that may be sent between the different locations 304, 306, 308. The workload experienced at a given time also impacts latency and limits achievable performance.

A user 326 is also connected to user location 308. In some approaches, the user 326 connects to the user location 308 through a compute device (e.g., such as the user's personal computer, mobile phone, etc.) such that information can be exchanged therebetween. However, in other approaches the user 326 may be able to access the user location 308 using one or more terminals having a user interface. The user 326 may also be connected to the network 310 in some implementations. Accordingly, the user 326 may access user location 308 and/or other locations in system 300 through the network 310 in such implementations. In still other implementations, the user may be able to access network 310 by using a direct connection to the user location 308, e.g., as would be appreciated by one skilled in the art after reading the present description.

It follows that user locations 306, 308 are able to receive data from the central data storage location 304 and even modify the data that is received. For example, data received from the central data storage location may be stored in the cache 324. Accordingly, data received from the central data storage location may be processed (e.g., modified) by a user as desired.

The cache 324 thereby provides compute resources that may be used at the user locations 306, 308 to perform requests received from users (e.g., see user 326) as well as data processing applications, machine learning models for evaluating data received, or other types of software, e.g., as would be appreciated by one skilled in the art after reading the present description. Moreover, by implementing operations in method 400 below, the system 300 (more specifically cache 324 at a user location 306, 308) is able to seamlessly process user requests and update a backup copy of data in storage while reducing impact on the system.

Looking now to FIG. 4, a method 400 for processing user data requests and updating a backup copy of data in storage while reducing impact on the system is illustrated in accordance with one embodiment. The method 400 may be performed in accordance with the present invention in any of the environments depicted in FIGS. 1-3, among others, in various embodiments. Of course, more or less operations than those specifically described in FIG. 4 may be included in method 400, as would be understood by one of skill in the art upon reading the present descriptions.

Each of the steps of the method 400 may be performed by any suitable component of the operating environment. For example, both of the nodes 401, 402 shown in the flowchart of method 400 may correspond to one or more processors positioned at a different location in a distributed data storage and processing system. Moreover, each of the one or more processors are preferably configured to communicate with each other.

In various embodiments, the method 400 may be partially or entirely performed by a controller, a processor, etc., or some other device having one or more processors therein. The processor, e.g., processing circuit(s), chip(s), and/or module(s) implemented in hardware and/or software, and preferably having at least one hardware component may be utilized in any device to perform one or more steps of the method 400. Illustrative processors include, but are not limited to, a central processing unit (CPU), an application specific integrated circuit (ASIC), a field programmable gate array (FPGA), etc., combinations thereof, or any other suitable computing device known in the art

As mentioned above, FIG. 4 includes different nodes 401, 402, each of which represent one or more processors, controllers, computer, etc., positioned at a different location in a distributed data storage system. For instance, node 401 may include one or more processors located at a central compute location (e.g., main server) of a distributed compute system (e.g., see central processor 314 of central data storage location 304 in FIG. 3 above). Node 402 may include one or more processors located at a first edge compute location of a distributed compute system (e.g., see processor 320 of user location 306 of FIG. 3 above). Accordingly, commands, data, requests, etc. may be sent between each of the nodes 401, 402 depending on the approach. Moreover, it should be noted that the various processes included in method 400 are in no way intended to be limiting, e.g., as would be appreciated by one skilled in the art after reading the present description. For instance, data sent from node 402 to node 401 may be prefaced by a request sent from node 401 to node 402 in some approaches.

Looking to FIG. 4, operation 404 includes sending a data request to node 401. As shown, the request originates from node 402. Accordingly, the request may be originated by a user, an application running at node 402, a procedure that is triggered in response to a predetermined condition being met, etc. For example, operation 404 may be triggered in response to an application attempting to modify (update) a file on a client machine in a distributed file system.

In response to receiving the data request at node 401, operation 406 includes accessing memory and retrieving the data requested. This process may differ depending on the type of memory, storage location, amount of data requested, etc. The requested data is thereafter returned to node 402, thereby satisfying the initial data request.

The data received at node 402 is stored in memory at node 402 in operation 410. The received data is preferably stored in cache, e.g., such that the received data may be evaluated and/or processed in response to being received. As noted above, the data request sent to node 401 in operation 404 may correspond to an application running at node 402, a user request received, etc. It follows that at least some of the requested data is often modified (e.g., deleted, appended to, overwritten, etc.) at the user location.

While several data operations may be performed which modify the data retrieved from storage, often a significant amount of this retrieved data is not modified at the user location at all. The data that is modified is preferably reflected in other copies of that data, but replacing existing data with a matching copy is a waste of compute overhead. Again, implementations herein only return data that has been modified to a central data storage location for processing and/or storage. Accordingly, data block copies determined as including unmodified data are discarded. The central data storage location can thereby use the modified data to update a corresponding copy of data, e.g., as described in further detail below.

At least some of the data received in operation 408 and stored in cache in operation 410 is modified (e.g., deleted, appended to, overwritten, etc.) by first creating a copy of each portion of data that is updated. See operation 412. Furthermore, operation 414 includes modifying the data in one or more data block copies created in operation 412. Thus, operations conducted on received data are performed using a copy of existing data. According to one example, in response to receiving a write operation at node 402 (e.g., from a user, running application, etc.), existing data referenced by the write operation is copied to create a duplicate copy of data. In response to creating the duplicate copy, the write operation is performed on the data in the duplicate copy.

By only performing data operations on data copies formed after the data operations are received allows for modified data to be more easily identified. As noted above, conventional systems have resorted to copying all data (including unmodified data) back to a central copy, thereby suffering from the strain placed on compute and/or network throughput. Moreover, these conventional systems modify data without keeping track of what specific portions of data have been updated. Accordingly, conventional systems have no choice but to copy all data back to a central copy and suffer these performance limitations.

In sharp contrast to these conventional drawbacks, operation 416 of method 400 includes identifying the specific data blocks that include modified data as a result of performing operation 414. As noted above, the data operations are performed on a copy of existing data which correspond to the data operations. Accordingly, the user location includes (stores) the data originally received from the central data storage location, and copies of the one or more data blocks that are modified as a result of performing data operations on the data stored therein. Moreover, this information may be stored in cache at the user location (e.g., see cache 324 in FIG. 3 above).

In one example, in response to receiving a write operation at node 402 (e.g., from a user, running application, etc.), existing data referenced by the write operation is copied to create a duplicate copy of data. In response to creating the duplicate copy, the write operation is performed on the data in the duplicate copy. This significantly reduces the amount of data that may be inspected to verify that all data modified at a user location has been reflected at a central copy of the data. For instance, while a given file may be referenced in a data write operation, fewer than every data block in the file may be modified as a result of performing the write operation on the file.

Proceeding to operation 418, a copy of the modified data blocks is sent to node 401. In other words, operation 418 includes sending the data blocks identified in operation 416 as including modified data as a result of performing operation 414, to a central data storage location. Again, this desirably allows for implementations herein to maintain an accurate copy of data that is updated in real-time to reflect operations performed at remote locations.

Operation 420 is illustrated as being performed at node 401 and includes processing (e.g., implementing) the modified data blocks in a central copy of data. For example, existing data in a backup copy of data stored at a central data storage location may be overwritten by the modified data blocks received in operation 418. As noted above, by only returning data blocks having modified data to a central data storage location, implementations herein are able to improve performance in a number of ways. For example, less compute throughput at the central data storage location is consumed as a result of only rewriting data that has been updated (changed) while avoiding data that has not been updated. Additionally, less data is sent between a user location and a central data storage location, thereby reducing network traffic.

Node 401 is thereby preferably able to receive and recognize a subset of data blocks that correspond to an existing file in storage. For instance, one or more processors at node 401 cause metadata to be read from the incoming data blocks to identify respective source file locations. Node 401 is also able to identify the corresponding data block locations in the file in storage. The node 401 is thereby able to append to, update, truncate, etc. the original data blocks of an existing file at the central data storage location using the metadata and length information present in the received data blocks that are sent from node 402.

From operation 420, method advances to operation 422. There, operation 422 includes sending an indication that the modified data blocks have been implemented at the central data storage location. In other words, operation 422 notifies node 402 (e.g., a user location) that the data modifications performed on the copies of data in operation 414 above, have successfully been applied to a corresponding (matching) copy of data at a central location.

In response to receiving the indication from node 401 that the modified data blocks have been implemented there, method 400 proceeds to operation 424. There, operation 424 includes replacing the existing data with the data copies having modified data. In other words, operation 424 includes using the modified data block copies to replace (e.g., overwrite) corresponding ones of the data blocks originally received from a central data storage location. Accordingly, data in the data blocks originally received from the central data storage location remains unmodified at the user location until receiving the indication that the modified data blocks have been implemented at the central data storage location. In other words, operation 424 may only be performed in response to receiving the indication in operation 422 from node 401 in some approaches. However, in other approaches operation 424 may be performed in response to a predetermined amount of time passing since the data was modified at the user location, receiving a user override, etc.

Again, the operations of method 400 are desirably able to improve performance in a number of ways. For example, less compute throughput is consumed at the central data storage location as a result of only rewriting data that has been updated (changed), while avoiding data that has not been updated. Additionally, less data is sent between a user location and a central data storage location, thereby reducing network traffic.

As noted above, operation 414 includes modifying the data in the one or more data block copies that are created in operation 412. Again, data operations typically reference the data that is accessed by the operations. This reference information can be used to create copies of the data, preferably such that the data operations are performed on a copy of existing data. However, the process of performing different types of data operations may involve different sub-operations.

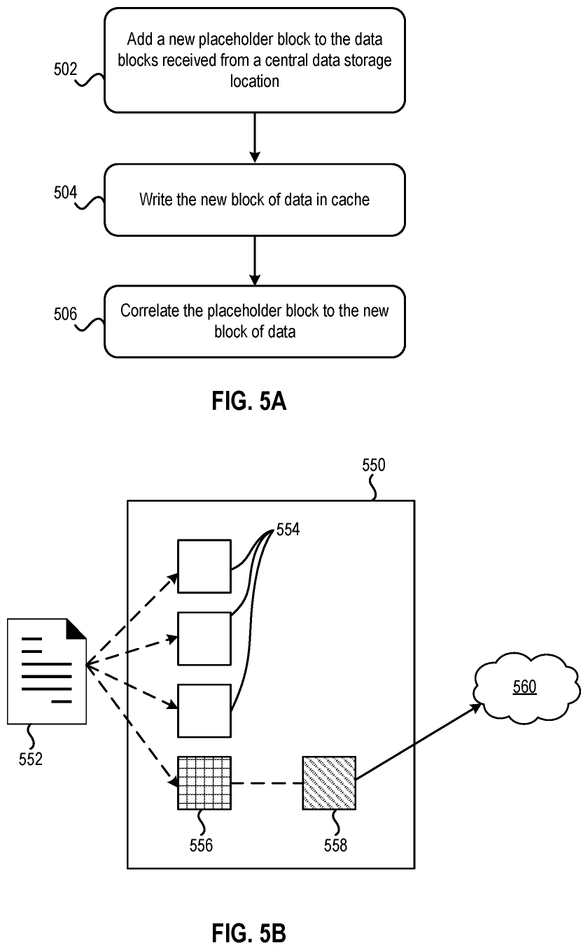

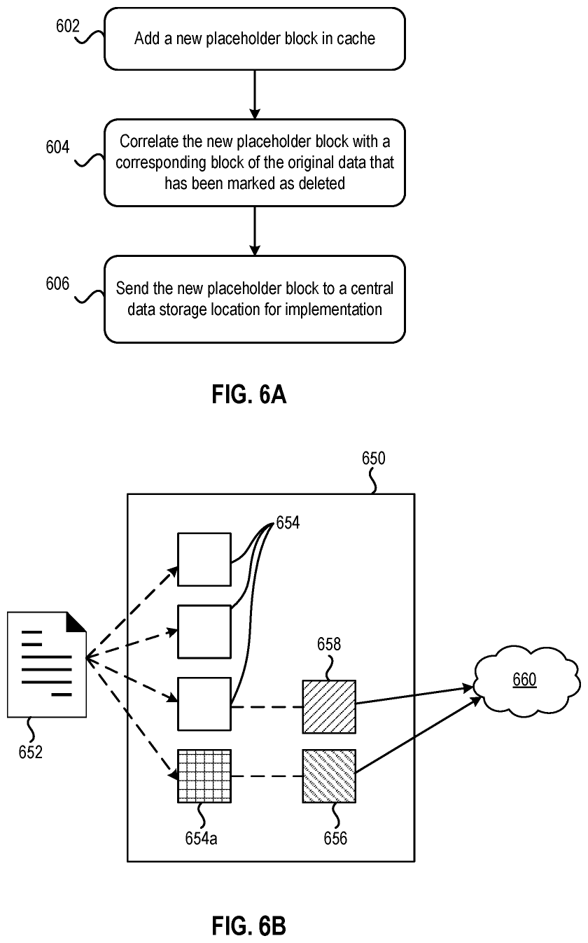

Accordingly, FIGS. 5A-6B illustrate exemplary sub-operations of modifying the data in the one or more data block copies in accordance with two different types of data operations. One or more of these sub-operations may thereby be used to perform operation 414 of FIG. 4. However, it should be noted that the sub-operations illustrated in FIGS. 5A-6B are illustrated in accordance with respective embodiments, neither of which are in any way intended to limit the invention.

Looking first to FIG. 5A, the sub-operations included therein correspond to performing a new data write operation. Moreover, FIG. 5B includes an illustrative implementation of the sub-operations shown in FIG. 5A. One or more of the sub-operations in FIG. 5A may thereby be performed in response to a user issuing a new data write request that involves writing one or more new blocks of data. The one or more new blocks of data do not replace (overwrite) any existing data, and therefore one or more placeholder blocks may be used, e.g., as will soon become apparent.

Sub-operation 502 of FIG. 5A includes adding a new placeholder block to the data blocks received from a central data storage location. In other words, sub-operation 502 includes creating a placeholder block that is correlated with existing data received from storage. The placeholder block is preferably created in cache at a user location. For instance, the placeholder block may append to an end of an existing set of data blocks stored in cache.

From sub-operation 502, the flowchart proceeds to sub-operation 504 which includes writing the new block of data in cache, while sub-operation 506 includes correlating the placeholder block to the new block of data. In other words, sub-operation 506 includes associating the new block of data with the multiple data blocks originally received. As noted above, modified copies of data are preferably modified at a central location before being fully implemented at a user location. Thus, the original (unmodified) data received from the central location and the modified copy of the original data are maintained in memory (e.g., cache) at the user location until the modified data has been recorded at the central location. The original (unmodified) data may thereby be replaced with the modified copy of the original data in response to receiving an indication that the new block of data has been implemented at the central data storage location.

Referring now to the illustration in FIG. 5B, a cache 550 at a user location is shown as receiving a data file 552 from storage (e.g., a central data storage location). The representational view shows the data file 552 includes existing data blocks 554. It follows that in situations where a new data write operation is performed such that data is appended to existing data blocks 554 of data file 552, new placeholder block 556 is created in the cache 550. Accordingly, new placeholder block 556 may be appended to the end of existing data blocks 554, or any one of the existing data blocks 554, e.g., depending on the desired implementation.

A new block of data 558 is also written to the cache 550. The new block of data 558 includes the data of the new data write operation and is preferably correlated to the placeholder block 556, as represented by the dashed line extending therebetween. The placeholder block 556 thereby serves as a target for the new block of data 558 in response to determining that data in the new block 558 has been added (appended) to a full copy of data at a central location. In other words, new block of data 558 eventually replaces (e.g., overwrites) the placeholder block 556 in response to determining that a copy of the new block of data 558 has been added to the central copy. Accordingly, the new block of data 558 is sent to a central data storage location over network 560 along with instructions to implement the new data block write at a central copy of data stored there. An indication that the new block of data 558 has been added at the central data storage location may also be received from network 560, as described herein.

Looking now to FIG. 6A, the sub-operations included therein correspond to performing a data deletion operation. Moreover, FIG. 6B includes an illustrative implementation of the sub-operations shown in FIG. 6A. One or more of the sub-operations in FIG. 6A may thereby be performed in response to a user issuing a data deletion request that involves deleting one or more blocks of existing data. The one or more blocks of data being deleted will not appear in the resulting copy of data, and therefore result in any data being transferred to a central location. Accordingly, one or more placeholder blocks may be used, e.g., as will soon become apparent.

Sub-operation 602 of FIG. 6A includes adding a new placeholder block in cache. The placeholder block is preferably created such that it is configured to indicate that a deletion request has been received. For instance, the placeholder block is preferably able to indicate that a deletion request has been received for a corresponding data block originally received from a central location. In some approaches, the placeholder block may include metadata that references data blocks originally received. Thus, the placeholder block may be used to convey that a corresponding block of data has been marked for deletion.

From sub-operation 602, the flowchart proceeds to sub-operation 604 which includes correlating the new placeholder block in cache with a corresponding block of the original data that has been marked as deleted. Moreover, sub-operation 606 includes sending the new placeholder block to a central data storage location for processing. In other words, sub-operation 604 includes implementing the data deletion at the central location. As noted above, the new placeholder block is preferably able to identify a data block that has been requested for deletion. The data at the central location can thereby be efficiently updated to reflect the removal of data as described in implementations herein.

As noted above, modified copies of data are preferably modified at a central location before being fully implemented at a user location. Thus, the original (unmodified) data received from the central location and the placeholder block are maintained in memory (e.g., cache) at the user location until the data deletion has been recorded at the central location. The original (unmodified) data may thereby be deleted, and the placeholder block may simply be deleted in response to receiving an indication that the deletion has been implemented at the central data storage location.

Looking now to the illustration in FIG. 6B, a cache 650 at a user location is shown as receiving a data file 652 from storage (e.g., a central data storage location). The representational view shows the data file 652 includes existing data blocks 654. It follows that in situations where a data deletion operation is performed such that at least some of the data in the existing data blocks 654 of data file 652 is deleted.

In response to receiving a deletion request that corresponds to one 654a of the existing data blocks 654, a new placeholder block 656 is created in the cache 650. Accordingly, new placeholder block 656 corresponds to one of the existing data blocks 654a as represented by the dashed line extending therebetween. As noted above, the placeholder block 656 is preferably configured to identify the corresponding block(s) that a deletion request has been received for. The placeholder block 656 may thereby be used to delete one or more data blocks in the data copy at a central data storage location.

Accordingly, the placeholder block 656 is sent to the central data storage location over network 660 for processing. One or more other data blocks may also be identified, e.g., using flags, data blocks partially filled with data, etc. For example, a partially filled data block 658 may be formed as a result of the deletion performed on the existing data blocks 654. In other words, the deletion may result in one or more full data blocks being deleted (e.g., see data block 654a) as well as one or more partial data block deletions (e.g., see data block 658). It follows that data block 658 is also preferably sent to the central data storage location over network 660.

In response to receiving an indication that the corresponding data blocks in a central data storage location have been fully and/or partially deleted, original data block 654a correlated with the placeholder block 656 may be removed from the cache 650. Similarly, data block 658 may be used to replace the corresponding one of the existing data blocks 654 in response to receiving an indication that the partial data block deletion has been recorded at the central data storage location.

Again, implementations herein are able to improve performance in a number of ways by only returning data blocks having modified data to a central data storage location. For example, less compute throughput is consumed at the central data storage location because only data that has been updated (changed) is rewritten, while avoiding data that has not been updated. Additionally, less data is sent between a user location and a central data storage location as a result, thereby reducing network traffic.

Reducing the amount of processing also reduces total power consumption, particularly at a central data storage location, thereby yielding additional benefits to operation costs. Furthermore, by performing data operations on copies of data that are formed after the data operations are received, allows for modified data to be more easily identified. Implementations herein are thereby able to further improve performance by reducing the computational overhead expended in order to identify the data blocks that include modified data.

A central data storage location may even include a file processing component (e.g., see 317 of FIG. 3) that is configured to recognize partial data (e.g., a subset of data blocks) for an existing file when supplied by a user location. Source files at the central location may be updated using metadata information received along with modified data blocks. Additionally, a file processing component (e.g., see 321 in FIG. 3) may be located at a user location that is able to perform partial data update operations (e.g., partial file writes), as well as full update operations (e.g., full file writes), depending on confirmation received from the server.

Certain aspects of the implementations described herein may further be improved as a result of implementing one or more machine learning models. These machine learning models may be trained to generate the order in which data operations are sent to a central location for implementation. For instance, a machine learning model (e.g., a neural network) may be trained using labeled and/or unlabeled data corresponding to past performance of a distributed system implementing any of the processes described herein. Over time, the machine learning model may thereby be able to identify a preferred order in which modified data is sent to the central location. This understanding will allow the machine learning model to determine an ideal order in which the modified data is mirrored at the central location, e.g., as would be appreciated by one skilled in the art after reading the present description.

It will be clear that the various features of the foregoing systems and/or methodologies may be combined in any way, creating a plurality of combinations from the descriptions presented above.

It will be further appreciated that embodiments of the present invention may be provided in the form of a service deployed on behalf of a customer to offer service on demand.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. (canceled)

2. The computer-implemented method of claim 3, wherein (i) the multiple data blocks received from the central data storage location, and (ii) the copies of the one or more data blocks, are stored in cache at a user location.

3. A computer-implemented method, comprising:
receiving multiple data blocks from a central data storage location;
modifying data in one or more of the data blocks, by:
creating copies of the one or more data blocks and the data included therein, and p2 modifying the data in the copies of the one or more data blocks;
sending a copy of the modified data blocks to the central data storage location; and
in response to receiving an indication that the modified data blocks have been implemented at the central data storage location, using the modified data blocks to replace corresponding ones of the data blocks received from the central data storage location,
wherein the method is performed at the user location.

4. The computer-implemented method of claim 3, wherein the multiple data blocks received from the central data storage location remain unmodified at a user location before receiving the indication that the modified data blocks have been implemented at the central data storage location.

5. The computer-implemented method of claim 3, comprising:
adding a new placeholder block to the multiple data blocks received from the central data storage location;
writing a new block of data in cache; and
correlating the placeholder block to the new block of data.

6. The computer-implemented method of claim 5, comprising:
in response to receiving an indication that the new block of data has been implemented at the central data storage location, replacing the placeholder block with the new block of data.

7. The computer-implemented method of claim 3, comprising:
deleting one of the multiple data blocks by:
adding a new placeholder block in cache, the new placeholder block being configured to indicate that a deletion request for a corresponding one of the data blocks received from the central data storage location has been received; and
sending the new placeholder block to the central data storage location for implementation.

8. The computer-implemented method of claim 7, wherein deleting one of the multiple data blocks includes:
in response to receiving an indication that the new placeholder block has been implemented at the central data storage location, deleting the modified data blocks to replace corresponding ones of the data blocks received from the central data storage location.

9. A computer program product, comprising a computer readable storage medium having program instructions embodied therewith, the program instructions readable by a processor, executable by the processor, or readable and executable by the processor, to cause the processor to:
receive multiple data blocks at a user location from a central data storage location;
modify data in one or more of the data blocks, by:
creating, at the user location, copies of the one or more data blocks and the data included therein, and
modifying, at the user location, the data in at least one of the copies of the one or more data blocks;
send secondary copies of only the modified data blocks from the user location to the central data storage location; and
use, in response to receiving an indication that the secondary copies of only the modified data blocks have been implemented at the central data storage location, the modified data blocks at the user location to replace corresponding ones of the data blocks at the user location received from the central data storage location.

10. The computer program product of claim 9, wherein (i) the multiple data blocks received from the central data storage location, and (ii) the copies of the one or more data blocks, are stored in cache at a user location.

11. The computer program product of claim 10, wherein the modifying, sending and using are performed at the user location.

12. The computer program product of claim 9, wherein the multiple data blocks received from the central data storage location remain unmodified at a user location before receiving the indication that the modified data blocks have been implemented at the central data storage location.

13. The computer program product of claim 9, wherein the program instructions are readable by the processor, executable by the processor, or readable and executable by the processor, to cause the processor to:
add a new placeholder block to the multiple data blocks received from the central data storage location;
write a new block of data in cache; and
correlate the placeholder block to the new block of data to associate the new block of data with the multiple data blocks received from the central data storage location.

14. The computer program product of claim 13, comprising:
in response to receiving an indication that the new block of data has been implemented at the central data storage location, replacing the placeholder block with the new block of data.

15. The computer program product of claim 9, wherein the program instructions are readable by the processor, executable by the processor, or readable and executable by the processor, to cause the processor to:
delete one of the multiple data blocks by:
adding a new placeholder block in cache, the new placeholder block being configured to indicate that a deletion request for a corresponding one of the data blocks received from the central data storage location has been received; and
sending the new placeholder block to the central data storage location for implementation.

16. The computer program product of claim 15, wherein deleting one of the multiple data blocks includes:
in response to receiving an indication that the new placeholder block has been implemented at the central data storage location, deleting the modified data blocks to replace corresponding ones of the multiple data blocks received from the central data storage location.

17. A system, comprising:
a processor; and
logic integrated with the processor, executable by the processor, or integrated with and executable by the processor, the logic being configured to:
receive multiple data blocks at a user location from a central data storage location;
modify data in one or more of the data blocks, by:
creating, at the user location, copies of the one or more data blocks and the data included therein, and
modifying, at the user location, the data in at least one of the copies of the one or more data blocks;
send secondary copies of only the modified data blocks from the user location to the central data storage location; and
in response to receiving an indication that the secondary copies of only the modified data blocks have been implemented at the central data storage location, use the modified data blocks at the user location to replace corresponding ones of the multiple data blocks at the user location received from the central data storage location.

18. The system of claim 17, wherein the logic is configured to:
add a new placeholder block to the multiple data blocks received from the central data storage location;
write a new block of data in cache; and
correlate the placeholder block to the new block of data to associate the new block of data with the multiple data blocks received from the central data storage location.

19. The system of claim 18, wherein the logic is configured to:
in response to receiving an indication that the new block of data has been implemented at the central data storage location, replace the placeholder block with the new block of data,
wherein unmodified ones of the data blocks are not sent to the central data storage location.

20. The system of claim 17, wherein the logic is configured to:
delete one of the multiple data blocks by:
adding a new placeholder block in cache, the new placeholder block being configured to indicate that a deletion request for a corresponding one of the data blocks received from the central data storage location has been received;
sending the new placeholder block to the central data storage location for implementation; and
in response to receiving an indication that the new placeholder block has been implemented at the central data storage location, deleting the modified data blocks to replace corresponding ones of the data blocks received from the central data storage location.

21. The computer-implemented method of claim 3, wherein the sending the copy of the modified data blocks to the central data storage location includes:
sending secondary copies of only the modified data blocks from the user location to the central data storage location, wherein unmodified ones of the data blocks are not sent to the central data storage location.
